(19) United States
(12) Patent Application Publication
(10) Pub. No.: US 2020/0277222 A1
(43) Pub. Date: Sep. 3, 2020

(54) METHOD FOR MANUFACTURING COVER GLASS, COVER GLASS, AND DISPLAY DEVICE

(71) Applicant: AGC Inc., Chiyoda-ku (JP)

(72) Inventors: Yasuhiro Inoue, Tokyo (JP); Atsushi Inoue, Tokyo (JP)

(73) Assignee: AGC Inc., Chiyoda-ku (JP)

(21) Appl. No.: 16/802,619

(22) Filed: Feb. 27, 2020

(30) Foreign Application Priority Data
Feb. 28, 2019 (JP) 2019-035699

(51) Int. Cl. C03C 15/00

(52) U.S. Cl. CPC C03C 15/00; C03C 21/002

(57) ABSTRACT

A method for manufacturing a cover glass includes covering partial regions of both main surfaces of a glass sheet with a mask material. The partial regions is opposed to each other. The method further includes etching the glass sheet having the partial regions covered with the mask material by use of an etchant, thereby obtaining a small-piece glass sheet having chamfered portions in the both main surfaces. The method further includes further chamfering at least a part of one main surface of the small-piece glass sheet, thereby providing a difference between surface roughness Ra of the chamfered portion on the one main surface side and surface roughness Ra of the chamfered portion on the other main surface side.

### CROSS-REFERENCE TO RELATED APPLICATIONS

This application claims priority from Japanese Patent Application No. 2019-035699 filed on Feb. 28, 2019, the entire subject matter of which is incorporated herein by reference.

### BACKGROUND OF INVENTION

### Technical Field

The present invention relates to a method for manufacturing a cover glass, a cover glass, and a display device.

### Background Art

Patent Literature 1 discloses “a cover glass that covers a display panel of a display device, the cover glass including a front surface that does not face the display panel, a back surface that faces the display panel, a front chamfered portion that is a chamfered portion on the front surface side, and a back chamfered portion that is a chamfered portion on the back surface side, wherein surface roughness Ra of the front chamfered portion exceeds 100 nm, and surface roughness Ra of the back chamfered portion is 100 nm or less” ([Claim 1]).

In the cover glass according to Patent Literature 1, Patent Literature 1 describes that “the surface roughness Ra of the back chamfered portion 13b is 100 nm or less, so that occurrence of cracking in the cover glass 12 can be prevented, and the cover glass 12 can have excellent impact resistance in an edge portion thereof” (paragraph [0024]).

In addition, in the cover glass according to Patent Literature 1, Patent Literature 1 describes that “the surface roughness Ra of the front chamfered portion 13a exceeds 100 nm, so that occurrence of gradation can be prevented, and defective display in the edge portion can be prevented” (paragraph [0021]).
Patent Literature 1: WO 2017/208995 A1

### SUMMARY OF INVENTION

As described above, Patent Literature 1 discloses a cover glass in which there is a difference between surface roughness Ra of a chamfered portion (front chamfered portion) on one main surface side and surface roughness Ra of a chamfered portion (back chamfered portion) on the other main surface side.

Specifically the cover glass according to Patent Literature 1 is, for example, manufactured as follows.

“A glass sheet is ground and chamfered by use of a chamfering wheel with coarse grain size (for example, grit number #600), so as to form a front chamfered portion 13a and a back chamfered portion 13b. After that, only the back chamfered portion 13b is ground by use of the chamfering wheel with fine grain size (for example, grit number #6000). Thus, a cover glass 12 in which the surface roughness Ra of the front chamfered portion 13a exceeds 100 nm and the surface roughness Ra of the back chamfered portion 13b is 100 nm or less can be obtained” (paragraph [0042]).

However, when the grain size of the chamfering wheel (grindstone) is changed from #600 to #6000 without any other grit number, the chamfering wheel (grindstone) is damaged. In fact, it is however necessary to increase the grit number from #600 gradually in multistage steps until finally reaching the grit number #6000. Such a manufacturing process is very complicated.

Therefore, an object of the present invention is to simply and easily obtain a cover glass in which there is a difference between surface roughness Ra of a chamfered portion on one main surface side and surface roughness Ra of a chamfered portion on the other main surface side.

The present inventors performed extensive studies, and found that the object could be achieved by using the following configuration.

That is, the present invention provides the following [1] to [11].

[1] A method for manufacturing a cover glass, comprising:

covering partial regions of both main surfaces of a glass sheet with a mask material, the partial regions being opposed to each other;

etching the glass sheet having the partial regions covered with the mask material by use of an etchant, thereby obtaining a small-piece glass sheet having chamfered portions in the both main surfaces; and

further chamfering at least a part of one main surface of the small-piece glass sheet, thereby providing a difference between surface roughness Ra of the chamfered portion on the one main surface side and surface roughness Ra of the chamfered portion on the other main surface side.

[2] The method for manufacturing a cover glass according to [1], comprising further chamfering a side face portion of the small-piece glass sheet.

[3] The method for manufacturing a cover glass according to [1] or [2], wherein a plurality of the mask materials are disposed in a main surface direction of the glass sheet.

[4] The method for manufacturing a cover glass according to [3], wherein an interval between the mask materials adjacent to each other in the main surface direction of the glass sheet is equal to or less than a thickness of the glass sheet.

[5] The method for manufacturing a cover glass according to any one of [1] to [4], wherein the glass sheet has a thickness of 0.5 mm to 2.5 mm.

[6] The method for manufacturing a cover glass according to any one of [1] to [5], wherein:

the etchant is an aqueous solution containing hydrogen fluoride; and

a content of the hydrogen fluoride in the etchant is 2 mass % to 10 mass %.

[7] The method for manufacturing a cover glass according to any one of [1] to [6], wherein the etchant has a temperature of 10° C. to 40° C.

[8] The method for manufacturing a cover glass according to any one of [1] to [7], wherein the glass sheet having the partial regions covered with the mask material is a glass sheet that has been subjected to an antiglare treatment.

[9] The method for manufacturing a cover glass according to any one of [1] to [8], comprising subjecting the small-piece glass sheet to a chemical strengthening treatment after the chamfering.

[10] A cover glass obtained by the method according to any one of [1] to [9].

[11] A display device, comprising the cover glass according to [10].

According to the present invention, it is possible to simply and easily obtain a cover glass in which there is a difference between surface roughness Ra of a chamfered portion on one main surface side and surface roughness Ra of a chamfered portion on the other main surface side.

### BRIEF DESCRIPTION OF DRAWINGS

FIG. 1 is a sectional view of a glass sheet covered with mask materials.

FIG. 2 is a sectional view of a small-piece glass sheet obtained by etching.

FIG. 3 is a sectional view of the small-piece glass sheet subjected to chamfering.

FIG. 4 is a sectional view of an on-vehicle display device.

FIG. 5 is a perspective view of a test body.

FIG. 6 is a sectional view taken on line A-A in FIG. 5.

FIG. 7 is a plan view of the test body.

### DETAILED DESCRIPTION OF THE INVENTION

Embodiment of the present invention are described below with reference to the drawings. However, the present invention is not limited to the following embodiments. Various modifications and replacements may be made on the following embodiments without departing from the scope of the present invention.

Surface roughness Ra (arithmetic average roughness) is a value measured in accordance with JIS B 0601:2001.

### [Method for Manufacturing Cover Glass]

A method for manufacturing a cover glass in an embodiment of the present invention (hereinafter also simply referred to as “manufacturing method of the present invention”) is a method for manufacturing a cover glass as follows. That is, the method for manufacturing a cover glass includes: covering partial regions of both main surfaces of a glass sheet with a mask material, the partial regions being opposed to each other; etching the glass sheet having the partial regions covered with the mask material by use of an etchant, thereby obtaining a small-piece glass sheet having chamfered portions in the both main surfaces; and further chamfering at least a part of one main surface of the small-piece glass sheet, thereby providing a difference between surface roughness Ra of the chamfered portion on the one main surface side and surface roughness Ra of the chamfered portion on the other main surface side.

The manufacturing method of the present invention is a method for obtaining a cover glass in which there is a difference between surface roughness Ra of a chamfered portion on one main surface side and surface roughness Ra of a chamfered portion on the other main surface side.

In the background art, such a cover glass can be obtained in a complicated manner in which chamfering is performed with a grindstone whose grain size is increased gradually in multistage steps (paragraph [0042] in Patent Literature 1).

On the other hand, chamfering is performed only once in the manufacturing method of the present invention. Thus, such a cover glass can be obtained simply and easily.

In addition, in the background art, work for cutting a large-size glass sheet to obtain a plurality of small-size glass sheets is required as a stage prior to chamfering.

On the other hand, in the manufacturing method of the present invention, a plurality of small-size glass sheets can be obtained at one time by etching without cutting. Also in this respect, the manufacturing method of the present invention is simple and easy.

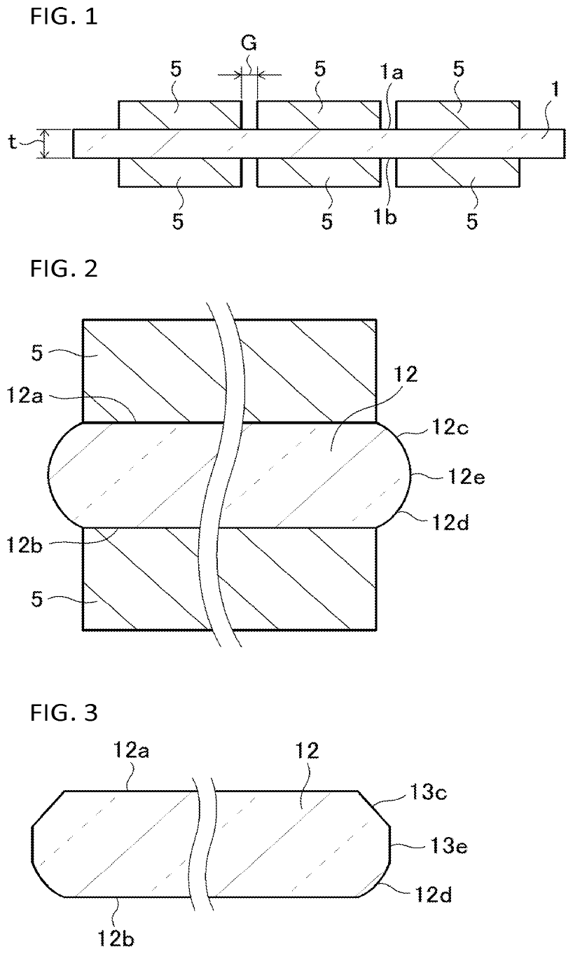

The manufacturing method of the present invention is described below more in detail with reference to FIG. 1 to FIG. 3.

### (Masking)

FIG. 1 is a sectional view of a glass sheet 1 having partial regions covered with a mask material 5.

The glass sheet 1 has one main surface 1a and the other main surface 1b. First, partial regions of the both main surfaces of the glass sheet 1 are covered with the mask material 5, partial regions being opposed to each other. That is, a partial region of the main surface 1a of the glass sheet 1 and a partial region of the main surface 1b opposed thereto are covered with the mask material 5. The partial regions opposed to each other preferably have the same shape (the same size) as each other.

Examples of glass of the glass sheet 1 include soda lime glass, aluminosilicate glass (SiO₂—Al₂O₃—Na₂O based glass), and the like. In the case where a chemical strengthening treatment is performed as described below, a glass for chemical strengthening which is based on aluminosilicate glass (for example, “Dragontrail (registered trademark)” may be also used suitably.

The thickness (represented by the reference sign tin FIG. 1) of the glass sheet 1 is preferably 0.5 mm to 2.5 mm and more preferably 0.7 mm to 2.0 mm for the reasons described below.

The dimensions of the main surfaces (the main surface 1a and the main surface 1b) of the glass sheet 1 are set appropriately.

An antiglare (AG) treatment may be performed on the glass sheet 1 to be covered with the mask material 5. A method for the AG treatment is not limited particularly. Examples of the method include a method of etching a surface layer of the glass sheet 1; a method of applying coating liquid including fine particles and a matrix to a surface of the glass sheet 1 and hardening the matrix; and the like.

The material of the mask material 5 is not limited particularly as long as it is a material resistant to an etchant described below. A material common in the background art may be selected and used suitably.

A film-like mask material is, for example, used as the mask material 5. As a specific example, an acid-resistant PET (polyethylene terephthalate) material coated with an acrylic pressure-sensitive adhesive may be used suitably.

A curable resin may be applied to the glass sheet 1 by use of a bar coater or the like, and hardened to form the mask material 5. Examples of the curable resin include a UV-curing resin and a thermosetting resin. Examples of the UV curable resin include an acrylate based radical polymerizable resin and an epoxy based cation polymerizable resin. Examples of the thermosetting resin include an epoxy resin, a phenolic resin, a urea resin, a melamine resin, an unsaturated polyester resin, a polyurethane resin, a diallyl phthalate resin, a silicone resin, and an alkyd resin. The UV curable resin is preferred because its curing rate is so high that the tact time can be shortened.

As shown in FIG. 1, a plurality of mask materials 5 may be disposed in the main surface direction (the left/right direction in FIG. 1) of the glass sheet 1. In this manner, a plurality of small-piece glass sheets 12 (see FIG. 2 and FIG. 3 described below) can be obtained from the glass sheet 1.

On this occasion, each interval (represented by the reference sign G in FIG. 1) between the mask materials 5 adjacent to each other in the main surface direction of the glass sheet 1 is preferably equal to or less than the thickness t (equal to or less than one times as large as the thickness t), preferably equal to or less than ½ times as large as the thickness t, and more preferably equal to or less than ⅓ times as large as the thickness t. On the other hand, the interval G is preferably equal to more than 1/10 times as large as the thickness t, and more preferably equal to more than ⅛ times as large as the thickness t.

In the case where the interval G between the mask materials 5 adjacent to each other is within the aforementioned range, a chamfered portion 12c, a side face portion 12e and a chamfered portion 12d of each obtained small-piece glass sheet 12 can form a convex curve (curved surface) easily.

### (Etching)

Next, the glass sheet 1 having the partial regions covered with the mask material 5 is etched with an etchant. Thus, a portion of the part of the glass sheet 1, which is not covered with the mask material 5, is dissolved by the etchant so that a small-piece glass sheet 12 smaller than the glass sheet 1 can be obtained.

FIG. 2 is a sectional view of the small-piece glass sheet 12 obtained by etching. The small-piece glass sheet 12 has chamfered portions in the both main surfaces.

That is, the small-piece glass sheet 12 has a chamfered portion 12c on one main surface 12a side and a chamfered portion 12d on the other main surface 12b side.

The small-piece glass sheet 12 further has a side face portion 12e which is connected to the chamfered portion 12c and the chamfered portion 12d.

As shown in FIG. 2, the chamfered portion 12c, the side face portion 12e and the chamfered portion 12d are connected to one another to thereby form a convex curve (curved surface).

Here, “convex” means that any straight line parallel to the thickness direction (the up/down direction in FIG. 2) of the small-piece glass sheet 12 and the outline of the small-piece glass sheet 12 intersect each other at two or less points. In the case of not the convex curve but a concave curve where they intersect each other at three or more points, it is extremely difficult to process not only the chamfered portion 12c during the chamfering process described below.

In a region of the glass sheet 1 (see FIG. 1), which is not covered with the mask material 5, dissolving starts on the both main surface sides and advances gradually toward the central portion. The central portion tends to remain without being dissolved, as compared with the both main surface sides. Thus, the chamfered portion 12c, the side face portion 12e and the chamfered portion 12d can form a convex curve.

In addition, the chamfered portion 12c, the side face portion 12e and the chamfered portion 12d are formed not by grinding with a grindstone but by etching with an etchant. Therefore, they form a smooth curve (curved surface). As a result, the chamfered portion 12c, the side face portion 12e and the chamfered portion 12d have very small surface roughness Ra.

The etchant is not limited particularly. The etchant is, for example, an aqueous solution containing hydrogen fluoride.

In this case, the content of the hydrogen fluoride in the etchant is preferably 2 mass % to 10 mass %.

In the case where the content of the hydrogen fluoride in the etchant is 2 mass % or higher, the processing time by etching can be shortened comparatively so that processing can be performed with good productivity.

On the other hand, in the case where the content is 10 mass % or lower, a variation in etching rate for each of the obtained small-piece glass sheets 12 can be reduced so that processing can be performed uniformly.

In order to further enhance those effects, the content of the hydrogen fluoride in the etchant is more preferably 4 mass % to 8 mass %.

In order to reduce the variation in etching rate and perform uniform processing on the obtained small-piece glass sheets 12, the temperature of the etchant is preferably 10° C. to 40° C., and more preferably 20° C. to 30° C.

The etching method is not limited particularly, but the glass sheet 1 having the partial regions covered with the mask material 5 is preferably immersed in the etchant.

The immersing time (etching time) in the etchant may be changed suitably depending on the sheet thickness of the glass sheet 1. The immersing time becomes longer with increase in thickness of the glass sheet 1.

For example, when the thickness of the glass sheet 1 is 0.5 mm to 2.5 mm, the etching time is preferably 20 minutes or longer, and more preferably 30 minutes or longer, and the etching time is preferably 600 minutes or shorter, and more preferably 300 minutes or shorter.

After the etching, the mask material 5 is removed suitably.

### (Chamfering)

Next, one main surface of the small-piece glass sheet 12 obtained by etching is further chamfered. Specifically, the chamfered portion 12c on the one main surface 12a side of the small-piece glass sheet 12 is, for example, chamfered by grinding with a chamfering wheel (grindstone) or the like.

FIG. 3 is a sectional view of the small-piece glass sheet 12 which has been subjected to chamfering. By the chamfering, another chamfered portion 13c different from the curved chamfered portion 12c is formed in the small-piece glass sheet 12 as shown in FIG. 3.

The chamfered portion 13c formed by grinding with the chamfering wheel (grindstone) or the like has a rougher face than the original chamfered portion 12c formed by etching.

On the other hand, chamfering is not performed on the chamfered portion 12d on the other main surface 12b side. Therefore, the curved chamfered portion 12d formed by etching is kept as it is.

In this manner, in the small-piece glass sheet 12 subjected to the chamfering, there is a difference between surface roughness Ra of the chamfered portion 13c on the one main surface 12a side and surface roughness Ra of the chamfered portion 12d on the other main surface 12b.

Chamfering may be performed on the side face portion 12e of the small-piece glass sheet 12 in the same manner. Thus, another side face portion 13e different from the curved side face portion 12e is formed in the small-piece glass sheet 12.

In the case where chamfering is performed on the side face portion 12e, the side face portion 13e formed newly is shaped into a straight line substantially parallel to the thickness direction of the small-piece glass sheet 12. Thus, the small-piece glass sheet 12 can be attached easily when it is attached as a cover glass to a display device.

The chamfering conditions (grit number of the grindstone, processing rate, grinding amount, and the like) may be selected suitably depending on desired surface roughness Ra of the chamfered portion 13c (desired surface roughness Ra of the chamfered portion 13c and desired surface roughness Ra of the side face portion 13e when the side face portion 13e is formed).

For the chamfering, as long as the number of steps does not increase excessively to complicate the work, rough processing may be first performed with a grindstone with rough grain size, and then, finishing processing may be performed with a grindstone with fine grain size.

### (Chemical Strengthening Treatment)

In the manufacturing method of the present invention, a chemical strengthening treatment may be performed on the small-piece glass sheet 12 after the aforementioned chamfering. Even when the chemical strengthening treatment is performed, the value of the surface roughness Ra is normally unchanged.

When the chemical strengthening treatment is performed, a glass for chemical strengthening is used as a glass.

According to a typical method for the chemical strengthening treatment, a glass is immersed in molten salt of KNO₃ for an ion exchange treatment, and then cooled down to the vicinity of room temperature. The treatment conditions such as the temperature of the molten salt of KNO₃, the immersing time, and the like may be set so that a desired surface compressive stress (CS) of a compressive stress layer and a desired thickness (DOL) of the compressive stress layer can be obtained.

The surface compressive stress (CS) of the compressive stress layer is preferably 500 MPa or more, more preferably 650 MPa or more, and even more preferably 750 MPa or more, and the surface compressive stress (CS) of the compressive stress layer is preferably 1,200 MPa or less.

The thickness (DOL) of the compressive stress layer is preferably 10 μm or more, more preferably 15 μm or more, even more preferably 25 μm or more, and particularly preferably 30 μm or more. The thickness (DOL) of the compressive stress layer is preferably 50 μm or less.

When the chemical strengthening treatment is performed, the small-piece glass sheet 12 which has been subjected to the chemical strengthening treatment serves as a cover glass 12 (described below).

On the other hand, when the chemical strengthening treatment is not performed, the small-piece glass sheet 12 which has been chamfered but has not been subjected to the chemical strengthening treatment serves as a cover glass 12 (described below).

### [Cover Glass]

Hereinafter, the cover glass 12 is described below with reference to FIG. 3. In the following description, parts the same as (or corresponding to) those in the small-piece glass sheet 12 which has been chamfered are referenced correspondingly.

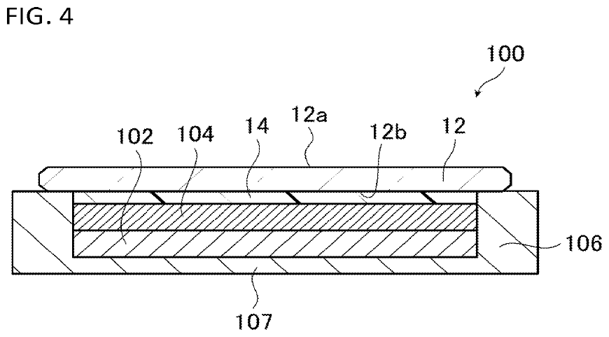

The cover glass 12 has a front surface 12a which does not face a display panel 104 (see FIG. 4) described below, and a back surface 12b which faces the display panel 104 on the opposite side to the front surface 12a.

Further, the cover glass 12 has a front chamfered portion 13c which is a chamfered portion on the front surface 12a side, a back chamfered portion 12d which is a chamfered portion on the back surface 12b side, and a side face portion 13e which is connected to the front chamfered portion 13c and the back chamfered portion 12d.

The thickness of the cover glass 12 is preferably 0.5 mm to 2.5 mm, and more preferably 0.7 mm to 2.0 mm. In the case where the thickness of the cover glass 12 is within the aforementioned range, durability against bending fracture in the back surface 12b can be enhanced in a head impact test described below.

The outer shape and dimensions of the cover glass 12 may be determined suitably depending on its use. For example, the outer shape is rectangular.

The dimensions of the cover glass 12 are, for example, 100 mm to 900 mm in its longitudinal direction and 40 mm to 500 mm in its lateral direction when the outer shape is rectangular. The dimensions are preferably 100 mm to 800 mm in the longitudinal direction and 40 mm to 300 mm in the lateral direction.

The size of the front surface 12a or back surface 12b of the cover glass 12 is, for example, preferably 5 inches to 20 inches.

An antireflection film may be provided on the front surface 12a of the cover glass 12. The thickness of the antireflection film is, for example, about 100 nm to 300 nm. As the material of the antireflection film and the method for forming the same, for example, a material and a deposition method described in paragraphs [0029] to [0030] of Patent Literature 1 may be used.

However, in the case where the antireflection film is formed in the front chamfered portion 13c, gradation may occur in the front chamfered portion 13c. The occurrence of the gradation may be recognized as poor appearance (poor appearance in an edge portion).

In order to prevent the occurrence of gradation and prevent poor appearance in an edge portion, surface roughness Ra of the front chamfered portion 13c is preferably more than 100 nm, more preferably 140 nm or more, even more preferably 170 nm or more, and particularly preferably 210 nm or more. The surface roughness Ra is preferably 500 nm or less, and more preferably 400 nm or less.

A cover glass for an on-vehicle display device is required to have impact resistance high enough not to be cracked by a head portion of a passenger colliding therewith when a vehicle crash occurs.

In the case where a head portion of a passenger collides with an edge portion of the cover glass 12, a large stress is generated in the back chamfered portion 12d. Due to the generated stress, the cover glass 12 may be cracked from a flaw (made during processing) in the back chamfered portion 12d as a start point.

In order to prevent cracking of the cover glass 12 and provide excellent impact resistance in an edge portion, surface roughness Ra of the back chamfered portion 12d is preferably 100 nm or less, more preferably 70 nm or less, even more preferably 30 nm or less, and particularly preferably 10 nm or less. The surface roughness Ra is preferably 0.1 nm or more.

The cover glass 12 can be obtained through the aforementioned masking, etching and chamfering (further optionally the chemical strengthening treatment). The back chamfered portion 12d of the cover glass 12 obtained thus has not undergone grinding with a grindstone or the like. Therefore, the state after the etching is kept as it is, and thus, the number of fine cracks (also referred to as “micro-cracks”) is very small. Thus, cracking is further prevented, and the impact resistance in the edge portion is more excellent.

However, the micro-cracks are very fine cracks. There is no suitable means for grasping the present state of the micro-cracks in the back chamfered portion 12d. Therefore, the features of the back chamfered portion 12d of the cover glass 12 cannot be specified directly from its physical structure or properties.

In addition, an extremely large number of trials and errors are required to find out some index other than the micro-cracks based on a large number of measurements repeated using various devices in order to grasp the features of the back chamfered portion 12d. It is therefore not practical to find out such an index.

Next, an on-vehicle display device which is mounted on a vehicle is described as a display device using the cover glass 12 with reference to FIG. 4.

The on-vehicle display device is, for example, a car navigation device, or a rear seat entertainment (RSE) device on which passengers at rear seats can watch video and so on.

The car navigation device is often used in a state where it is provided to stand on an exterior portion of a dash board or it is embedded in the dash board.

The RSE device is often used in a state where it is attached to the back side of a front seat.

However, the display device is not limited to such an on-vehicle display device.

### [On-Vehicle Device]

FIG. 4 is a sectional view of an on-vehicle display device 100.

The on-vehicle display device 100 has a housing 106 for receiving members thereof. A backlight unit 102 is mounted on a housing bottom sheet 107 which is a bottom sheet of the housing 106. A display panel 104 is mounted on the backlight unit 102. The display panel 104 is, for example, a liquid crystal panel. An opening portion is formed in the housing 106.

The configurations of the backlight unit 102 and the display panel 104 are not limited particularly. Common configurations may be used. The material and so on of the housing 106 (including the housing bottom sheet 107) are also not limited particularly.

The on-vehicle display device 100 may have, for example, an organic EL panel, a PDP, an electronic ink type panel, or the like. The on-vehicle display 100 may have a touch panel or the like.

The cover glass 12 is pasted on the display panel 104 through a pressure-sensitive adhesive layer 14. The cover glass 12 functions as a protective member for the display panel 104.

The pressure-sensitive adhesive layer 14 is preferably transparent like the cover glass 12, and there is preferably a small difference in refractive index between the cover glass 12 and the pressure-sensitive adhesive layer 14. Examples of the pressure-sensitive adhesive layer 14 include a layer made of a transparent resin obtained by curing a liquid curable resin composition, and an OCA (Optical Clear Adhesive) film or tape. The thickness of the pressure-sensitive adhesive layer 14 is, for example, 5 μm to 400 μm, and preferably 50 μm to 200 μm.

### Examples

The present invention is described specifically below with reference to examples thereof. However, the present invention is not limited to the following examples.

### <Manufacturing Cover Glass>

Cover glasses 12 in Case 1 to Case 4 were manufactured according to the manufacturing method of the present invention described with reference to FIG. 1 to FIG. 3. Case 1 to Case 4 are examples of the present invention.

### <<Masking>>

First, a glass for chemical strengthening (“Dragontrail” made by AGC Inc.) subjected to an AG treatment was prepared as the glass sheet 1. The thickness t of the glass sheet 1 was set to vary among Case 1 to Case 4 as shown in the following Table 1.

Next, the mask materials 5 were disposed on the main surface 1a and main surface 1b of the glass sheet 1 as shown in FIG. 1. A film (resistant to acid) of a PET material coated with an acrylic pressure-sensitive adhesive was used as the mask materials 5. The interval G between the mask materials 5 adjacent to each other was set at ½ of the thickness t of the glass sheet 1.

### <<Etching>>

The glass sheet 1 coated with the mask materials 5 was immersed in an etchant, thereby performing etching. Thus, small-piece glass sheets 12 which were small in size were obtained.

Each obtained small-piece glass sheet 12 had a chamfered portion 12c, a side face portion 12e and a chamfered portion 12d, these forming a convex curve (curved surface) as shown in FIG. 2.

An aqueous solution containing 6 mass % of hydrogen fluoride was used as the etchant. The temperature of the etchant was set at 25° C. The etching time varied depending on the thickness t of the glass sheet 1 as shown in the following Table 1.

After the etching, the mask materials 5 were removed.

### <<Chamfering>>

The small-piece glass sheet 12 obtained by the etching was chamfered.

More specifically, the chamfered portion 12c on the one main surface 12a side and the side face portion 12e in the small-piece glass sheet 12 were ground by use of a chamfering wheel (grindstone). Thus, another chamfered portion 13c and another side face portion 13e which were rougher than the curved chamfered portion 12c and the curved side face portion 12e were formed in the small-piece glass sheet 12 as shown in FIG. 3.

Specifically in the chamfering process, rough processing (grindstone grit number: #325, processing rate: 1,200 mm/min, grinding amount: 0.4 mm) was performed by use of a chamfering wheel (grindstone) with rough grain size. After that, finishing processing (grindstone grit number: #600, processing rate: 800 mm/min, grinding amount: 0.1 mm) was performed by use of a chamfering wheel (grindstone) with fine grain size.

### <<Chemical Strengthening Treatment>>

A chemical strengthening treatment was applied to the small-piece glass sheet 12 which had been chamfered. The chemical strengthening treatment was performed by immersing the whole of the glass sheet into molten salt of KNO₃ so as to form a compressive stress layer with a thickness (DOL) of 35 μm and a surface compressive stress (CS) of 750 MPa.

In the aforementioned manner, the cover glasses 12 in Case 1 to Case 4 were obtained.

The value of the surface roughness Ra of the front chamfered portion 13c and the value of the surface roughness Ra of the back chamfered portion 12d in each of the cover glasses 12 in Case 1 to Case 4 are shown in the following Table 1.

The surface roughness Ra was measured by a laser microscope “VK-9500” made by Keyence Corporation in accordance with JIS B 0601:2001. A cutoff value λ_{c} was set at 0.25 mm.

In this manner, in each of Case 1 to Case 4, the cover glass 12 in which there was a difference between the surface roughness Ra of the front chamfered portion 13c and the surface roughness Ra of the back chamfered portion 12d could be obtained simply and easily without cutting a large-size glass sheet or increasing the grain size of a grindstone in multistage steps (equal to or more than three steps).

### <Manufacturing Test Body>

A test body 200 of an on-vehicle display device was manufactured using each of the cover glasses 12 in Case 1 to Case 4 in order to perform a test for making a rigid body model collide therewith (also referred to as “head impact test”).

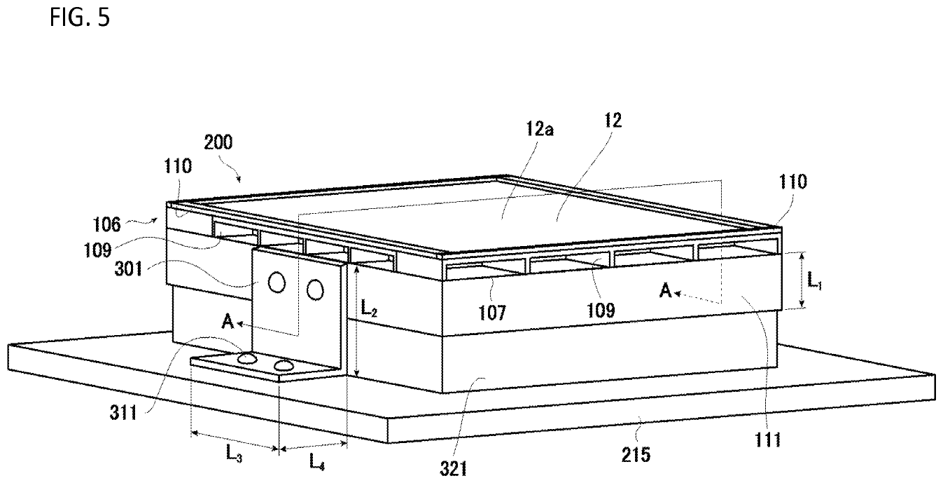

The test body 200 is described with reference to FIG. 5 to FIG. 7. In FIG. 5 to FIG. 7, parts the same as (or corresponding to) those of the on-vehicle display device 100 in FIG. 4 are referenced correspondingly, and description thereof may be omitted.

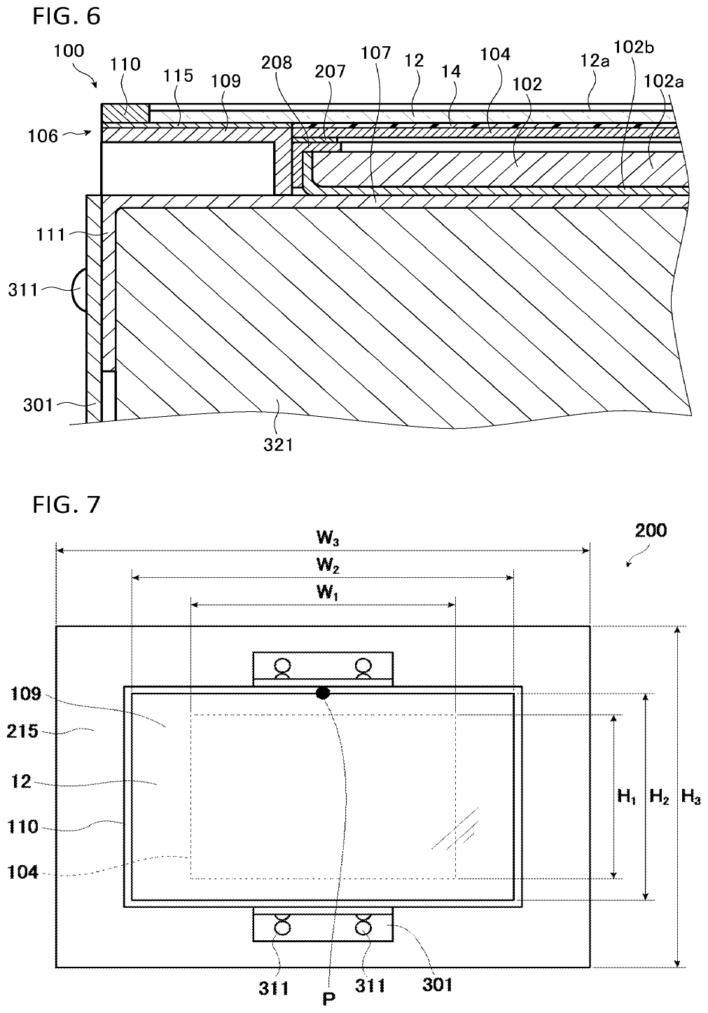

FIG. 5 is a perspective view of the test body 200. FIG. 6 is a sectional view taken on line A-A in FIG. 5. FIG. 7 is a plan view of the test body 200.

As shown in FIG. 5 and FIG. 6, the test body 200 has a housing bottom sheet 107. Four housing frames 109 having ribs attached thereto internally are disposed on a periphery of the housing bottom sheet 107. A housing 106 having a rectangular recess portion in its central region is formed by the housing bottom sheet 107 and the four housing frames 109. A backlight unit 102 and a display panel 104 are disposed inside the housing 106.

As shown in FIG. 6, a top-side edge portion of the backlight unit 102 is covered with an L-shaped member 208 having an L-shape in section. The top surface of the L-shaped member 208 and a bottom-side edge portion of the display panel 104 are bonded to each other through a double-sided tape 207. Therefore, between the display panel 104 and the backlight unit 102, there is an air gap (1.5 mm) corresponding to the total thickness of the L-shaped member 208 and the double-sided tape 207. A pressure-sensitive adhesive layer 14 is pasted on the top surface of the display panel 104. The bottom surface of the cover glass 12 and the top surface of the housing frame 109 are pasted to each other through a double-sided tape 115. A housing edge frame 110 is disposed outside the edge face of the cover glass 12 and on the top surfaces of the housing frames 109. The housing edge frame 110 is also pasted to the housing frames 109 through the double-sided tape 115.

As shown in FIG. 5 and FIG. 6, plate-like housing protrusion portions 111 are provided in the four sides of the housing bottom sheet 107 so as to be continuously connected to the housing bottom sheet 107. A recess portion is formed on the back side (on the opposite side to the backlight unit 102) of the housing bottom sheet 107 by the housing bottom sheet 107 and the four housing protrusion portions 111. A part of a cushion material 321 enters into the recess portion. The cushion material 321 is disposed on a support plate 215 which is a flat plate. The housing 106 is supported by the cushion material 321. Two pieces of “CF45” (thickness: 25.4 mm) made by K. C. C. Shokai Co., Ltd. put on top of each other are used as the cushion material 321. In a state where the housing 106 is supported by the cushion material 321, one ends of fixation portions 301 are bonded to a pair of housing protrusion portions 111 opposed to each other by bolts 311. The other ends of the fixation portions 301 are bonded to the support plate 215 by bolts 311. Thus, the housing 106 including the housing protrusion portions 111 is fixedly positioned by the fixation portions 301.

As for each fixation portion 301 which is a plate-like member having an L-shape in section, the dimensions represented by L₁ to L₄ in FIG. 5 were set as L₁: 20 mm, L₂: 50 mm, L₃: 100 mm, and L₄: 20 mm.

The dimensions represented by H₁ to H₃ and W₁ to W₃ in FIG. 7 were set as H₁: 120 mm, H₂: 150 mm, H₃: 250 mm, W₁: 173 mm, W₂: 250 mm, and W₃: 350 mm.

The other portions were set as follows.
Pressure-sensitive adhesive layer 14 . . . OCA (“MHM-FWD” made by Nichiei Kakoh Co., Ltd., thickness: 150 μm)
Display panel 104 . . . alternative in which polarizing plates (material: TAC) were pasted on the both sides of a soda lime glass (having a thickness of 1.1 mm and a dimension of 173 mm×120 mm) was used.
Backlight unit 102 . . . alternative in which a bottom surface and four side faces of a plate-like body 102a (material: PC, thickness: 4 mm, dimensions: 117 mm×170 mm) were covered with a concave body 102b (material: aluminum, thickness: 1 mm) was used.
Double-sided tape 207 . . . material: PET, tape width: 5 mm, thickness: 0.5 mm
L-shaped member 208 . . . material: PVC, thickness: 1 mm, one side length of L-shape: 5 mm
Housing frame 109 . . . material: ABS, thickness: 2 mm
Housing edge frame 110 . . . material: ABS, thickness: 2.5 mm, sheet width: 5 mm
Double-sided tape 115 . . . material: PET, thickness: 0.5 mm
Fixation portion 301 . . . material: iron (SS400), thickness: 1.0 mm
Bolt 311 . . . material: iron
Cushion material 321 . . . two pieces of “CF45” made by K. C. C. Shokai Co., Ltd. (thickness: 25.4 mm) put on top of each other
Support plate 215 . . . material: iron, thickness: 9 mm
Housing bottom sheet 107 and housing protrusion portion 111 . . . material: iron, thickness: 1.15 mm

### <Evaluation of Impact Resistance in Edge Portion (Head Impact Test)>

Using the test body 200 manufactured thus, a head impact test was preformed and the impact resistance in an edge portion of the cover glass 12 was evaluated.

The support plate 215 of the test body 200 was placed on a horizontal plane. A not-shown spherical rigid body model (material: iron, diameter: 165 mm, mass: 19.6 kg) was made to fall from a height of 793 mm and collide at a collision position P (see FIG. 7) in the front surface 12a of the cover glass 12 at a collision speed of 3.944 m/s so that energy at the collision reached 152.4 J.

As for the testing method, “Attachment 28: Technical Standard of Impact Absorption of Instrument Panel” of “Article 20: Riding Device” in “Maintenance Standard of Road Transportation Vehicles” (hereinafter simply referred to as “Standard”) represented by the Ministry of Land, Infrastructure and Transport was referred to. In this “Standard”, a spherical rigid body model (material: iron, diameter: 165 mm, mass: 6.8 kg) is shot to collide at a collision speed of 6.7 m/s so that energy at the collision reaches 152.4 J.

That is, in the head impact test using the test body 200, the energy at the collision was made equivalent to that in “Standard”.

Deceleration of the rigid body model is stipulated not to exceed 784 m/s² (80 G) continuously for 3 ms (milliseconds) or more. It was confirmed that any test performed this time satisfied this stipulation.

In view from top of the test body 200, the collision position P (see FIG. 7) on the cover glass 12 that the rigid body model was made to collide with was closer to one of the fixation portions 301 than the central position and 1 mm inside from the endmost portion of the cover glass 12.

Test bodies 200 using the cover glasses 12 in Case 1 to Case 4 were manufactured, and the head impact test was performed on each of the test bodies 200.

As a result of the test, a cover glass 12 which was not cracked was evaluated as “A”, and a cover glass 12 which was cracked was evaluated as “B”. The evaluations were described in the following Table 1. If a cover glass 12 is evaluated as “A”, the cover glass 12 can be evaluated as excellent in impact resistance in an edge portion thereof

### <Evaluation of Poor Appearance in Edge Portion>

An antireflection film having a thickness of 243 nm was formed on the front surface 12a of the cover glass 12 in each of Case 1 to Case 4 by sputtering. On this occasion, it was confirmed that an antireflection film was also formed on the front chamfered portion 13c.

The antireflection film was specifically an antireflection film in which a total of four layers of niobium oxide and silicon oxide were deposited sequentially from the cover glass 12 side. The antireflection film was formed by the manner described in paragraphs [0105] to [0106] in JP 2016-029474 A.

Next, a cover glass was removed from a commercially available on-vehicle display device for a rear seat, and the cover glass 12 on which the antireflection film was formed was attached in place to the on-vehicle display device. The used on-vehicle display device for a rear seat was a display device which was of a type in which an edge portion of the cover glass was not received in a housing but was exposed therefrom (see FIG. 4). Therefore, an edge portion of the attached cover glass 12 was not received in the housing but was exposed therefrom. Next, on the following conditions 1 to 3, it was checked whether the edge portion of the cover glass 12 developed a color in gradation to sparkle or not.

Condition 1: The cover glass standing perpendicularly to the ground was observed from a place at a distance of 80 cm.

Condition 2: The cover glass was observed within a range of 45° at most in a vertical direction from a perpendicular plane to the cover glass.

Condition 3: The cover glass was observed on the condition that indoor illuminance was set at 1500 lx (lux).

As a result, a cover glass where no gradation was observed was evaluated as “A”, and a cover glass where gradation was observed was evaluated as “B”. The evaluations are described in the following Table 1. If a cover glass is evaluated as “A”, the cover glass can be evaluated as capable of preventing poor appearance in an edge portion.

TABLE 1

| | | Case 1 | Case 2 | Case 3 | Case 4 |
|---|---|---|---|---|---|
| Thickness t [mm] of glass sheet | | 0.7 | 1.1 | 1.3 | 2.0 |
| Etching time [min] | | 58 | 92 | 108 | 167 |
| Front chamfered portion | Ra [nm] | 380 | 261 | 298 | 335 |
| Back chamfered portion | Ra [nm] | 85 | 80 | 76 | 71 |

| | | | | |
|---|---|---|---|---|
| Impact resistance in edge portion | A | A | A | A |
| Poor appearance in edge portion | A | A | A | A |

### <Summary of Evaluation Results>

As is apparent from the results shown in Table 1, impact resistance in an edge portion was excellent and poor appearance in the edge portion was prevented when the cover glasses 12 in Case 1 to Case 4 were used.

| | |
|---|---|
| 1 | Glass sheet |
| 1a | One main surface of glass sheet |
| 1b | The other main surface of glass sheet |
| 5 | Mask material |
| 12 | Small-piece glass sheet (cover glass) |
| 12a | One main surface of small-piece glass sheet (front surface |
| | of cover glass) |
| 12b | The other main surface of small-piece glass sheet (back |
| | surface of cover glass) |
| 12c | Chamfered portion on one main surface side of small-piece |
| | glass sheet |
| 12d | Chamfered portion on the other main surface side of small- |
| | piece glass sheet (back chamfered portion of cover glass) |
| 12e | Side face portion of small-piece glass sheet |
| 13c | Chamfered portion on one main surface side of small-piece |
| | glass sheet (front chamfered portion of cover glass) |
| 13e | Side face portion of small-piece glass sheet (side face |
| | portion of cover glass) |
| 14 | Pressure-sensitive adhesive layer |
| 100 | On-vehicle display device |
| 102 | Backlight unit |
| 104 | Display panel |
| 106 | Housing |
| 107 | Housing bottom sheet |
| 109 | Housing frame |
| 110 | Housing edge frame |
| 111 | Housing protrusion portion |
| 115 | Double-sided tape |
| 200 | Test body |
| 207 | Double-sided tape |
| 208 | L-shaped member |
| 215 | Support plate |
| 301 | Fixation portion |
| 311 | Bolt |
| 321 | Cushion material |
| G | Interval between mask materials adjacent to each other |
| P | Collision position |
| t | Thickness of glass sheet |

1. A method for manufacturing a cover glass, comprising:
covering partial regions of both main surfaces of a glass sheet with a mask material, the partial regions being opposed to each other;
etching the glass sheet having the partial regions covered with the mask material by use of an etchant, thereby obtaining a small-piece glass sheet having chamfered portions in the both main surfaces; and
further chamfering at least a part of one main surface of the small-piece glass sheet, thereby providing a difference between surface roughness Ra of the chamfered portion on the one main surface side and surface roughness Ra of the chamfered portion on the other main surface side.

2. The method for manufacturing a cover glass according to claim 1, comprising further chamfering a side face portion of the small-piece glass sheet.

3. The method for manufacturing a cover glass according to claim 1, wherein a plurality of the mask materials are disposed in a main surface direction of the glass sheet.

4. The method for manufacturing a cover glass according to claim 3, wherein an interval between the mask materials adjacent to each other in the main surface direction of the glass sheet is equal to or less than a thickness of the glass sheet.

5. The method for manufacturing a cover glass according to claim 1, wherein the glass sheet has a thickness of 0.5 mm to 2.5 mm.

6. The method for manufacturing a cover glass according to claim 1, wherein:
the etchant is an aqueous solution containing hydrogen fluoride; and
a content of the hydrogen fluoride in the etchant is 2 mass % to 10 mass %.

7. The method for manufacturing a cover glass according to claim 1, wherein the etchant has a temperature of 10° C. to 40° C.

8. The method for manufacturing a cover glass according to claim 1, wherein the glass sheet having the partial regions covered with the mask material is a glass sheet that has been subjected to an antiglare treatment.

9. The method for manufacturing a cover glass according to claim 1, comprising subjecting the small-piece glass sheet to a chemical strengthening treatment after the chamfering.

10. A cover glass obtained by the method according to claim 1.

11. A display device, comprising the cover glass according to claim 10.
